(19) United States
(12) Patent Application Publication
(10) Pub. No.: US 2015/0235189 A1
(43) Pub. Date: Aug. 20, 2015

(54) GENOMIC SEQUENCE BANKING SYSTEM

(71) Applicant: Sang Kook Jeong, Fairfield, CT (US)

(72) Inventor: Sang Kook Jeong, Fairfield, CT (US)

(21) Appl. No.: 14/181,156

(22) Filed: Feb. 14, 2014

(51) Int. Cl. G06Q 20/10; G06F 19/00

(52) U.S. Cl. CPC G06Q 20/10; G06F 19/322

(57) ABSTRACT

A genomic sequence banking system is provided. A depositor may first deposit genomic sequence data into a gene bank. Companies or researchers (third parties) may have access to the information. The third parties may pay per amount of data used. A share of payments may be paid to depositors of genetic data. The genetic information may be entrusted to the gene bank and may be the sole property of the depositor.

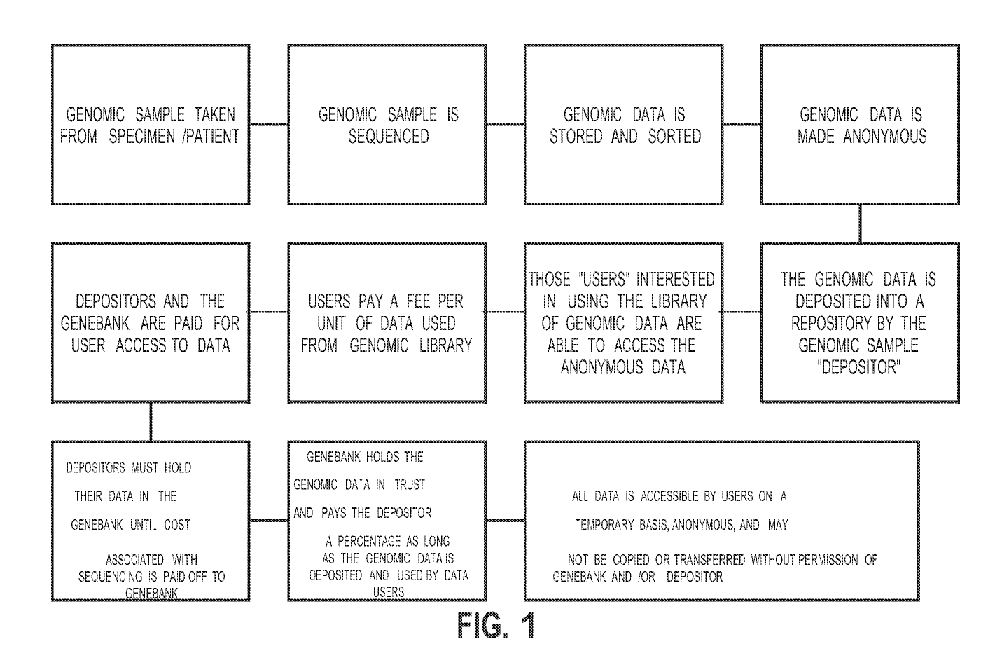

### CROSS-REFERENCE TO RELATED APPLICATION

This application claims the benefit of priority of U.S. provisional application No. 61/764,376, filed Feb. 13, 2013, the contents of which are herein incorporated by reference.

### BACKGROUND OF THE INVENTION

The present invention relates to a genomic sequence banking system and, more particularly, to a banking system that provides genomic sequence data in exchange for a monetary value.

Acquiring genetic data for medical research or industrial use is inhibited by the lack of large pools of population data. Genomic data is held by research labs or governmental agencies and provides no monetary incentive for data collection and sharing. This is due to the fact that the current system of genetic data acquisition relies solely on medical problems provoking interest in the research community to sequence specific areas of a genome.

As can be seen, there is a need for an improved method of storing and accessing genetic data.

### SUMMARY OF THE INVENTION

In one aspect of the present invention, a system for providing genomic data to a third party, comprises: a machine having a user interface; and a program product comprising machine-readable program code for causing, when executed, the machine to perform the following process steps: prompting a depositor to submit sequence genomic data; storing the submitted sequence genomic data in a database; and prompting a third party to access the sequence genomic data on the database in exchange for a monetary value.

These and other features, aspects and advantages of the present invention will become better understood with reference to the following drawings, description and claims.

### BRIEF DESCRIPTION OF THE DRAWINGS

The FIGURE is an exemplary flow chart of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a genomic sequence banking system where genomic sequence information is deposited by a depositor. Companies or researchers (third parties) may have access to the information. The third parties may pay per amount of data used. A share of payments may be paid to depositors of the genetic data. The genetic information may be entrusted to the gene bank and may be the sole property of the depositor. Further, the depositor identity may be made anonymous to the third party user. With the advent of new sequencing technologies, the opportunity for mass sequencing is possible. The present invention provides a trust for such information to be used for the greater good, while providing monetary incentives for the holders of this genetic information.

Creating a bank that allows for transacting personal (human or any living organism with DNA) genetic information in exchange for a monetary value may create an incentive for sharing genetic data. Much like a bank deposit, the genetic information is on loan to the gene bank and may be used as long as it is deposited. A monetary value may be paid for an amount of usage of the data much like interest accrued on a bank account. The data may remain the property of the depositor, but is held in trust to the gene bank for any debts or obligations to the gene bank, such as the initial cost of sequencing a genomic profile of a depositor, the cost of storing the data, and the like.

The present invention may facilitate a plurality of benefits. The present invention may solve the need for collecting genomic data for research since the present invention facilitates the storage of massive amounts of genomic data. The present invention may also provide income to those for whom other sources of income are limited. The present invention further rewards the owners of the genetic data in a systematic, fair, equitable and an anonymous way. The massive collection of genomic data may further include a library of genomic data for all known organisms, including people, on Earth at any point in time.

Referring to the Figures, the present invention may include the following. A genomic sample may be taken from a specimen or patient i.e. the depositor. The genomic sample is then sequenced using a genomic sequencer. The genomic data may then be stored and sorted. In certain embodiments the genomic sequencer may be connected to a cloud or standard computer servers to directly upload the data into the database. The computer may be used to analyze and organize this genomic information for storage into the cloud based or free standing data storage system i.e. a genomic information repository.

In certain embodiments, the gene bank of the present invention may make the genomic data anonymous. Therefore, the present invention may include an interface for depositors to deposit data anonymously and withdraw the genomic data at any time. The data may be securely stored and entrusted to the gene bank and may be withdrawn at any time, as the owner of the information is the depositor.

Corporations and research facilities may access the data stored by the gene bank. The corporations and research facilities may be considered third party users. The third party users may access the database for a fee. In certain embodiments, the third party users may pay a subscription to access the data. In certain embodiments, the third parties pay a fee based on how much data the third party has used. The data usage charges may also fluctuate based on the type of data used such as different medical history metrics. The genomic information repository may be accessed by a computer system. The computer system may calculate the amount of data units of the stored genetic data that is being accessed and may then calculate the monetary value of that data to be charged to the third party user. Per amount of data used of each respective depositor's data, the depositors may be credited a percentage of the monies paid by the third party users. The gene bank may be paid for the remaining amount.

In certain embodiments, the depositors of the present invention may be required to hold their data within the gene bank until costs associated with sequencing the genomic sample is paid off to the gene bank. The gene bank may hold the genomic data in trust and pay the depositor a percentage as long as the genomic data is deposited and used by the third party users. In certain embodiments, the data may only be accessible by users on a temporary basis and may be anonymous. Further, the data may not be copied or transferred without the permission of the gene bank, and/or depositor.

In certain embodiments, the genomic sequencer may be directly connected to a massive data collection system. The present invention may include a system to input the data anonymously so that third party users are able to collect and use anonymous data without the ability to download the data permanently. Payment software may be utilized to pay depositors for each time their data is used by the third party users. The present invention may utilize an interface to receive the genomic sample (i.e. tissue sample), process the sample to extract genomic information, and collect the data to be stored in centralized or decentralized data storage for later use by third parties. The third party user's may be monitored for data use and charged accordingly.

In alternative embodiments, the present invention may be used by insurance companies and other business entities interested in health information. The information gathered in this system can be used by a variety of private and governmental organizations. Data on genetic variances in populations, comparison of health metrics (i.e. height, weight, medical history) can be correlated with genetic markers and variance, and mining for new genetic morphologies. The monetization of genetic information based on demand by third party users creates a unique opportunity in the financial sector to benefit from genetic information. There are many potential applications and uses in many fields with this process technology.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for providing genomic data to a third party, comprising:
a machine having a user interface; and
a program product comprising machine-readable program code for causing, when executed, the machine to perform the following process steps:
prompting a depositor to submit sequence genomic data;
storing the submitted sequence genomic data in a database; and
prompting a third party to access the sequence genomic data on the database in exchange for a monetary value.

2. The system of claim 1, further comprising the step of collecting a monetary value from the third party based on the amount of data accessed by the third party.

3. The system of claim 1, further comprising the step of prompting plurality of depositors to submit sequence genomic data.

4. The system of claim 3, further comprising the step of sorting and categorizing the submitted sequence genomic data of the plurality of depositors.

5. The system of claim 1, wherein the sequence genomic data is sequence genomic data of the depositor.

6. The system of claim 1, further comprising the step of providing a percentage of the monetary value to the depositor.

7. The system of claim 1, wherein a gene bank stores the sequence genomic data on the database.

8. The system of claim 7, wherein the depositor loans the gene bank the sequence genomic data, and thereby retains ownership of the sequence genomic data.

9. The system of claim 1, wherein the depositor remains anonymous to the third party.
